(19) United States
(12) Patent Application Publication
(10) Pub. No.: US 2010/0101777 A1
(43) Pub. Date: Apr. 29, 2010

(54) Mulitplate slip method and system

(76) Inventors: Simon Perales, Karnes City, TX (US); Ruben Soliz, Karnes City, TX (US)

Correspondence Address: PMI Oil Tools;C/O: Ramon Perales, P.O. Box 40, Karnes City, TX, 78118, US

(21) Appl. No.: 12/259,400

(22) Filed: Oct. 28, 2008

(51) Int. Cl. E21B 23/01; B23P 11/00

(52) U.S. Cl. 166/206; 29/428

(57) ABSTRACT

Detailed is one embodiment that is multi-plate slip system that has a base plate with a removable top plate that may be used to anchor a well tool to a well casing. Another embodiment is a method for attaching a top plate to a base plate in a multi-plate slip system such that the multi-plate slip system may be used to anchor a well tool to a well casing. Lastly another embodiment is a device that has a base plate with a removable top plate that may be used in a well tool to anchor the well tool to a well casing.

### BACKGROUND OF THE INVENTION

The invention relates to production oil tools, and, more specifically the invention relates to down-hole oil tools having a multi-plate slip.

### BRIEF SUMMARY OF THE INVENTION

### Interpretation Considerations

This section does not describe prior art as defined for purposes of anticipation or obviousness under 35 U.S.C. section 102 or 35 U.S.C. section 103. Thus, nothing stated in the BACKGROUND is to be construed as prior art.

### Discussion

Anchoring a well tool to the inside wall of a well casing is a practice of production engineers and well service personnel. This practice is widespread and is used when excavating natural resources, such as oil, from a well. Unfortunately, the force required to anchor the well tool to the well casing causing wear and damage to the slips of the well tool. This wear and damage makes it difficult for the slips to anchor the well tool to the well casing. In more extremely instances wear and damage renders a slip or more than one slip of the well tool unusable, rendering the entire well tool useless. Once a slip is worn or damaged, production engineers and well service personnel must order a replacement tool that is inconvenient and incurs additional cost for the production company.

### BRIEF DESCRIPTION OF THE DRAWINGS

For a detailed description of exemplary embodiments, reference will now be made to the accompanying drawings in which:

FIG. 1 illustrates a combined elevation and cross-sectional view of a well tool embodying the novel features of the present invention;

FIG. 2 illustrates a perspective view of a multi-plate slip system;

FIG. 3 illustrates a which illustrates a cross-sectional side view of the base plate;

FIG. 4 which illustrates a cross-sectional side view of the top plate;

FIG. 5 shows a method for a multi-plate slip system.

### DETAILED DESCRIPTION

### Interpretation Considerations

When reading this section which describes exemplary embodiments, one should keep in mind several points. First, the following exemplary embodiments are what the inventor believes to be the best mode for practicing the invention at the time this patent was filed. Thus, since one of ordinary skill in the art may recognize from the following exemplary embodiments that substantially equivalent structures or substantially equivalent acts may be used to achieve the same results in exactly the same way, or to achieve the same results in a not dissimilar way, the following exemplary embodiments should not be interpreted as limiting the scope of just the embodiments described.

Likewise, individual aspects (sometimes called species) of the exemplary embodiments are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the exemplary embodiments are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”). Fourth, unless explicitly stated otherwise, conjunctive words (such as “or”, “and”, “including”, or “comprising” for example) should be interpreted in the inclusive, not the exclusive, sense.

Accordingly, the various embodiments can be characterized as multi-plate slip system, method, and device. One embodiment is a multi-plate slip system that has a top plate that may be removably attached from a base plate. Another embodiment is a method for replacing a top plate in a multi-plate slip system. Yet another embodiment is a multi-plate slip device that has a top plate having a trapezoidal shaped groove enabled to receive a base plate having a trapezoidal shaped protruding tongue and at least one screw to removably attach the top plate to the base plate.

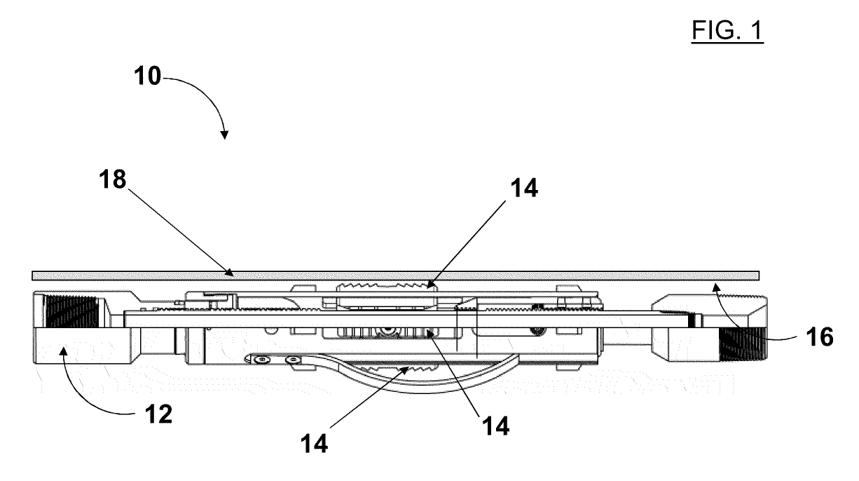

Reference is now made to FIG. 1, which illustrates a combined elevation and cross-sectional view of a well tool 10 in the form of an anchor 12 embodying the novel features of the multi-plate slip system 14. Examining FIG. 1, the multi-plate slip system 14 is embodied as a component in a slip mechanism that releasably secures the anchor 12 to an inside wall 16 of a well casing 18. The slip mechanism is the connection of two or more slips or mutli-plate slip systems 14 via springs (not shown). The anchor 12 may be manipulated vertically within a well to set and release the anchor 12 from a position against a well casing 20 via a tubing string (not shown). In some embodiments, the slip mechanism comprises at least one multi-plate slip system 14 that when deployed moves radially outward to set the anchor 12 to the well casing 18. Once set, the multi-plate slip system 14 reacts against forces directed at the anchor 12 by enabling the anchor 12 to remain in an anchored position against the well casing 18. Conversely, the slip mechanism may also comprise at least one multi-plate slip system 14 that when retrieved moves radially inward to release the anchor 12 from its anchored position against the well casing 18. Furthermore, in other embodiments the anchor 12 may comprise a plurality of multi-plate slip systems 14 to set and release the well tool 10 from an anchored position in a well casing 18.

A multi-plate slip system 14 may be made in various shapes and sizes and of various materials in order to best accommodate various types of well tools such as an anchor 12, a packer, or other well tools that are anchored or set within the well casing using a slip or slip system. It is apparent to those skilled in the art of manufacturing and using oil well, down hole, or oil tool systems and devices, that the present invention may be incorporated therein to such systems or devices to accomplish a similar form and function of the multi-plate system 14 described herein.

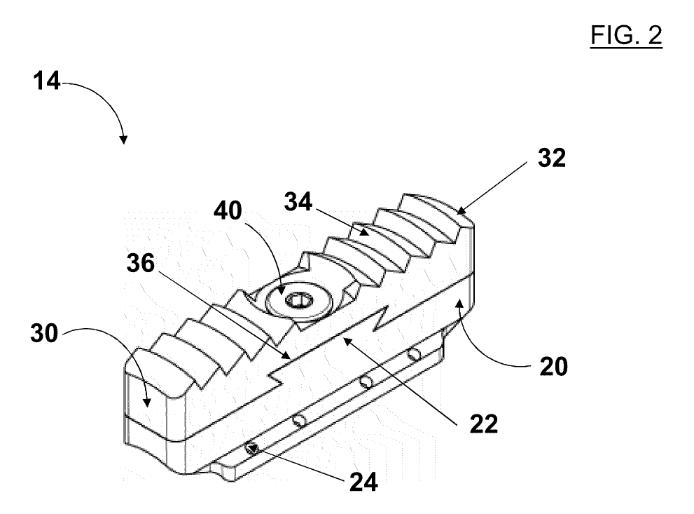

Reference is now made to FIG. 2 illustrating a perspective view of a multi-plate system 14. In one embodiment, the multi-plate system 14 comprises a base plate 20, a protruding tongue 22, and at least one opening 24 enabled to removably attach the base plate to another slip or multi-plate slip system 24 via a spring and a removable top plate 30 having a top side 32 comprising at least one row of wickers 34, a groove 36 enabled to receive the protruding tongue 22, and at least one circular passage (not shown) that originates at the top side 32 of the top plate 30 and terminates at the bottom side of the top plate 30 enabling a fastener 40 to pass through and at least one fastener 40 that attaches the top plate 30 to the base plate 20.

In one embodiment, the multi-plate system 14 comprises a single base plate 20 having at least one opening 24 enabled to removably attach the base plate 20 to another slip or multi-plate slip system 14 via at least one spring and a single top plate 30 that is removably attachable to the base plate 20 via at least one fastener 40. The fastener 40 may be any means that removably attaches the top plate 30 to the base plate 20. In FIG. 2, the fastener 40 embodied is a single screw. In another embodiment, the fastener 40 may be a plurality of screws. In yet other embodiments the fastener 40 may be a clip, snap, or bracket, for example.

It should also be apparent to those skilled in the art of manufacturing and using oil field tools and oil field tool components that the top plate 30 may comprise of a plurality of sub components, however when all subcomponents are assembled a single top plate 30 shall form that may be removably attached to the base plate 20. In addition, similar to the top plate 30, the base plate 20 may also comprise a plurality of sub components, however when all subcomponents are assembled a single base plate 20 shall form that is enabled to receive a removably attachable top plate 30.

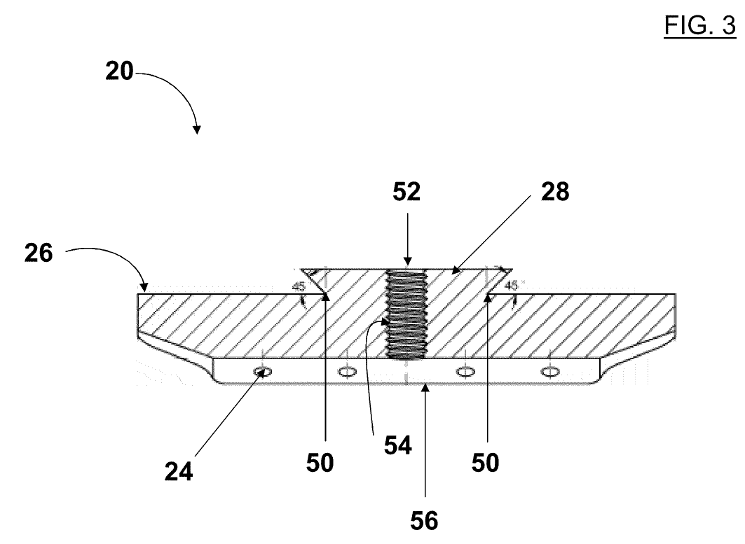

Reference is now made to FIG. 3, which illustrates a cross-sectional side view of the base plate 20. In one embodiment, the base plate 20 comprises a top side 26 having a tongue 28, integrally formed within, protruding away from the bottom side 56 of the base plate 20. In another embodiment, the tongue 28 may be removably attached to a portion of the base plate 24. In addition, the tongue 28 may be substantially trapezoidal shape and form a forty-five degree angle on the top side 26 of the base plate 20 near each intersection 50 of the base of the tongue 28 and the top side 26 of the base plate 20. In other embodiments, the base plate 20 may comprise a tongue 28 that is substantially rectangular, square, or circular in shape, for example, that accomplishes the function of enabling the top plate 30 to mount to and be removably attached to the base plate 20. In one embodiment, the base plate 20 may have a length of 4 inches, a width of 1 inch, and a height of 0.662 inches centrally located from the top most portion of the base plate 20 to the bottom most portion of the base plate 20 including the tongue 28. Furthermore, in other embodiments the tongue 28 may be generally or substantially circular, rectangular, dove-tailed, or other shapes that enable the top plate 30 to be removably attached to the base plate 20.

The base plate 20 further comprises a substantially circular socket 52 having a thread 54 embedded within. In the illustrated embodiment, the circular socket 52 originates at the top most centrally located portion of the tongue 28 and continues to the bottom most centrally located portion of the base plate 20. In other embodiments, the circular socket 52 may pass completely through the base most portion of the base plate 20 creating a threaded passage. In some embodiments, the base plate 20 comprises eight openings 24 that enable the multi-plate system 14 to be removably attached to other multi-plate slip systems 14 or slips via a spring.

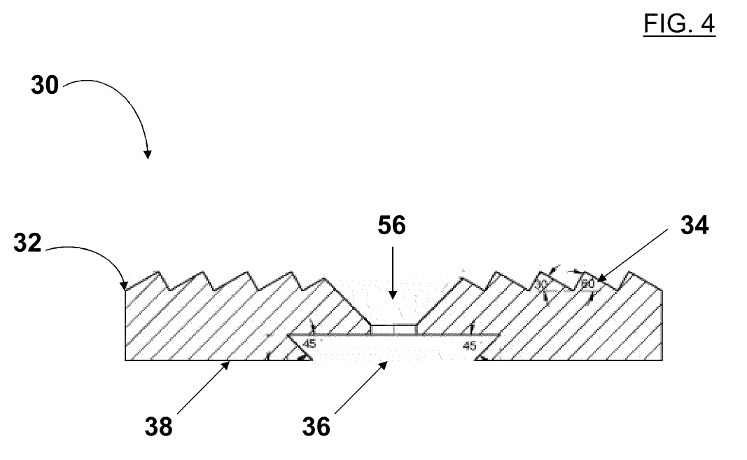

Reference is now made to FIG. 4 which illustrates a cross-sectional side view of the top plate 30. In one embodiment, the top plate 30 comprises a top side 32 having at least one row of wickers 34 generally protruding away from the top side 32 of the top plate 30. Each row of wickers 34 being formed by a 30 degree angle medial to the center most portion of the circular passage 56 and a 60 degree angle distal to the center most portion of the circular passage 56.

In addition, the top plate comprises a bottom side 38 having a groove 36 integrally formed within. The groove 36 is enabled to receive the tongue 28 protruding from the base plate 20. In one embodiment, the groove 36 is substantially trapezoidal in shape. In other embodiments, the groove 36 may be substantially rectangular, square, or circular in shape, for example, that accomplishes the function of enabling the top plate 30 to mount to and be removably attached to the base plate 20. In some embodiments, the tongue 28 and groove 36 may be similar in shape and size. Conversely, the tongue 28 and groove 36 may be substantially different in shape and size.

The top plate 30 further comprises a substantially circular passage 56 that originates at the top most centrally located portion of the top plate 30 and continues to the bottom most centrally located portion of the top plate 30 enabling a fastener 40 to pass through. In one embodiment, the top plate 30 is generally rectangular in shape and has a length of 4 inches, a width of 1 inch, and a height of 0.660 inches. It is apparent to those skilled in the art that other shapes, sizes, and dimensions of the top plate 30 can yield the same form, function, and use case.

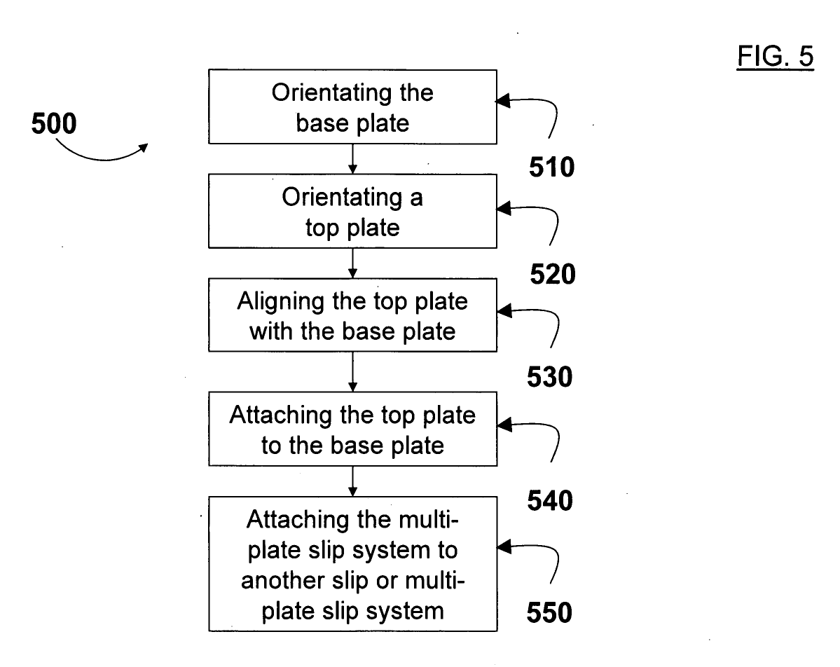

FIG. 5 illustrates a method for removably attaching a top plate 30 to a base plate 20 in a multi-plate slip system 14. The method 500 comprises orientating a base plate 20 (block 510) such that its top side 26 is facing radially outward from the well tool 10, orientating a top plate 30 (block 520) in one of a plurality of possible orientations, preferably such that the bottom side 38 of the top plate 30 is facing inward, aligning the top plate 30 with the base plate 20 (block 530) such that the bottom side 38 of the top plate 30 is generally parallel to the top side 26 of the base plate 20, attaching the top plate 30 to the base plate 20 (block 540), and attaching the multi-plate slip system 14 to another slip or multi-plate slip system 14 (block 550) via a spring. In some embodiments, orientating the base plate 20 (block 510) is the act of orientating the base plate 20 such that the tongue 28 protrudes radially outward and a portion of the top side 26 of the base plate 20 is parallel to the central axis of the well tool 10. In alternative embodiments, orientating the base plate 20 (block 510) whereby the base plate 20 may have multiple configurations, the method may comprise orientating the base plate 20 such that a portion of the top side 26 of the base plate 20 faces radially outward in a non-parallel orientation to the central axis of the well tool 10. Furthermore, orientating the base plate 20 (block 510) may comprise the act of orientating the base plate 20 in other suitable orientations which best fit other oil tool 10 geometries that incorporate in part of in entirety functions and features of the invention described herein.

Orientating the top plate 30 (block 520) comprises selecting one of multiple top plate 30 configurations. As illustrated in the figures incorporated herein the top plate 30 is shown in a preferred orientation, however, multiple top plate 30 configurations may be used to accomplish the intended uses and methods of the invention. It should also be apparent that in some embodiments whereby the top plate 30 may have multiple configurations or comprise subcomponents, the method may comprise orientating the top plate 30 such that its bottom side 38 is facing in a non-parallel orientation to the top side 26 of the base plate 20.

Aligning the top plate 30 and the base plate 20 (block 530) comprises aligning the bottom side 38 of the top plate 30 parallel to the top side 26 of the base plate 20 and aligning the passage 56 and socket 52 such that the fastener 40 may pass therein and removably attach the top plate 30 and the bottom plate 20. In one embodiment aligning the top plate 30 and the base plate 20 (block 530) also comprises aligning the tongue 28 and groove 36 such that the tongue 28 may slide or snap into the groove 36.

Attaching the top plate 30 to the base plate 20 (block 540) comprises removably attaching the top plate 30 and the base plate 20 securely together via a fastener 40. In some embodiments, the attaching of the top plate 30 to the base plate 20 (block 540) comprises removably attaching the top plate 30 to more than one socket 52 integrally formed within the base plate 20 via a series of fasteners 40. In some embodiments, attaching the top plate 30 to the base plate 20 may comprise sliding the tongue 28 and groove 36 together coupling the top plate 30 and the base plate 20 prior to removably attaching the top plate 30 and the base plate 20 securely together via a fastener 40. In other embodiments, attaching the top plate 30 to the base plate 20 may simply be achieved by attaching the top plate 30 to the bottom plate 20 via a single fastener 40 such as a screw.

Attaching the multi-plate slip system 14 to another slip or multi-plate slip system 14 (block 550) via a spring comprises attaching a first portion of a spring to an opening 24 of a first multi-plate slip system 14 and then attaching a second portion of the spring to an opening 24 of a second multi-plate slip system (not shown). In other embodiments, attaching the multi-plate slip system 14 to another slip or multi-plate slip system 14 (block 550) via a spring comprises attaching a first portion of a spring to an opening 24 of a first multi-plate slip system 14 and then attaching a second portion of the spring to an opening 24 of a non multi-plate slip system. Alternatively, in yet another embodiment attaching the multi-plate slip system 14 to another slip or multi-plate slip system 14 (block 550) via a spring comprises attaching a first portion of a spring to an opening 24 of a non multi-plate slip system and then attaching a second portion of the spring to an opening 24 of a multi-plate slip system 14.

The above discussion is meant to be illustrative of the principles and various embodiments of the multi-plate slip system 14. Numerous variations and modifications will become apparent to those skilled in the art once the above disclosure is fully appreciated. For example, the top plate 30 and the base plate 20 of the multi-plate slip system 14 may be interchangeable such that the base plate 20 may be used as a top plate 30 and the top plate 30 may be used as a base plate 20 in the multi-plate slip system 14 and providing the same intended form, function, or use of the multi-plate slip system 14.

It should also be noted that the multi-plate slip system 14 may be adapted to or incorporated within a well tool or well tools system having a slip ring and a slip retaining ring that sets a multi-plate slip system 14 within a portion of a well tool or a well tool system that removably attaches, sets, or anchors a well tool to a well casing. In this embodiment, the multi-plate slip system 14 is not required to connect to another slip via a slip spring however like form and functionality is accomplished as presented herein. With that said, it is intended that the following claims be interpreted to embrace all such variations, modifications, and derivations thereof.

What is claimed is:

1. A multi-plate slip system, comprising:
a base plate having a top side, a socket, and at least one opening enabled to removably attach the base plate to another slip via a spring;
a removable top plate having a top side, a bottom side, and at least one passage; and
at least one fastener that attaches the top plate to the base plate.

2. The multi-plate slip system of claim 1 whereby the base plate has a tongue that protrudes from a portion of the top side of the base plate.

3. The multi-plate slip system of claim 1 whereby the top plate has a groove integrally formed within a portion of the bottom side of the top plate enabled to receive the tongue.

4. The multi-plate slip system of claim 1 whereby the socket comprises a thread enabled to receive the fastener.

5. The multi-plate slip system of claim 1 whereby the fastener is a screw.

6. The multi-plate slip system of claim 1 whereby the passage originates at the top side of the top plate and pass through the bottom side of the top plate enabling a fastener to pass through.

7. The multi-plate slip system of claim 1 whereby the fastener is a clip.

8. The multi-plate slip system of claim 1 whereby the socket originates at the top side of the base plate.

9. The multi-plate slip system of claim 1 whereby a portion of the top side of the top plate comprises at least one row of wickers.

10. The multi-plate slip system of claim 1 whereby the top plate comprises more than one sub plate.

11. A method comprising:
orientating a base plate having at least one socket;
orientating a top plate having at least one passage;
aligning the base plate with the top plate; and
attaching the top plate to the base plate.

12. The method of claim 1 1 whereby orientating a base plate comprises orientating the base plate such that its top side is facing radially outward from the well tool.

13. The method of claim 11 whereby orientating the top plate in one of a plurality of positions comprises orientating the top plate such that its bottom side is generally parallel to the top side of the base plate.

14. The method of claim 11 whereby aligning the top plate with the base plate comprises aligning the bottom side of the top plate parallel to the top side of the base plate and aligning the passage and socket such that a fastener may pass therein and removably attach the top plate and the bottom plate.

15. The method of claim 11 whereby attaching the top plate to the base plate comprises removably attaching the top plate to the base plate via at least one fastener.

16. The method of claim 11 whereby attaching the multi-plate slip system to another multi-plate slip system comprises attaching a first portion of a spring to an opening of a multi-plate slip system and then attaching a second portion of the spring to an opening of a second multi-plate slip system.

17. A multi-plate slip system, comprising:
a base plate having a top side, a bottom side, a circular socket comprising a thread embedded within, a trapezoidal shaped protruding tongue integrally formed within a portion of the top side and protruding radially outward from the bottom side of the base plate, and at least one opening enabled to removably attach the base plate to another slip via at least one spring;
a removable top plate having a top side comprising at least one row of wickers having, a bottom side, a trapezoidal shaped groove integrally formed with the bottom side of the removable top plate enabled to receive the protruding tongue, and at least one circular passage that originates at the top side of the top plate and terminates at the bottom side of the top plate enabling a screw portion to pass through; and
at least one screw that attaches the top plate to the base plate.

18. The multi-plate slip system of claim 17 whereby the top plate comprises a plurality of sub plates enabled to attach to a base plate.

19. The multi-plate slip system of claim 17 whereby the top plate is generally rectangular in shape and having an overall length of 4 inches, an overall width of 1 inch, and an overall height of 0.660 inches.

20. The multi-plate slip system of claim 17 whereby the base plate is generally rectangular in shape having an overall length of 4 inches, an overall width of 1 inch, and an overall height of 0.662 inches.
